(19) United States
(12) Patent Application Publication
(10) Pub. No.: US 2023/0348321 A1
(43) Pub. Date: Nov. 2, 2023

(54) TRANSPARENT SUBSTRATE PROVIDED WITH THIN-FILM MULTILAYER COATING

(71) Applicant: HANKUK GLASS INDUSTRIES, INC., Seoul (KR)

(72) Inventors: Jin Woo HAN, Seoul (KR); Kangmin KIM, Seoul (KR)

(73) Assignee: HANKUK GLASS INDUSTRIES, INC., Seoul (KR)

(21) Appl. No.: 18/002,178

(22) PCT Filed: Jun. 8, 2021
(86) PCT No.: PCT/KR2021/007166

§ 371 Date: Dec. 16, 2022

(30) Foreign Application Priority Data
Jun. 17, 2020 (KR) 10-2020-0073874

(51) Int. Cl. C03C 17/36

(52) U.S. Cl. CPC C03C 17/366; C03C 17/3618; C03C 17/3626; C03C 17/3649; C03C 17/3639; C03C 17/3686

(57) ABSTRACT

Provided is a transparent substrate with a multilayer thin film coating. The multilayer thin film coating includes a lower dielectric layer, a lower protective layer, a metal functional layer having an infrared reflection function, an upper protective layer, and an upper dielectric layer, which are sequentially laminated from the transparent substrate, the lower dielectric layer includes at least one barrier layer and at least one impurity collection layer, and the thickness of the metal function layer is 12 nm or more.

### CROSS-REFERENCE TO RELATED APPLICATIONS

This application is a 35 U.S.C. § 371 national phase of PCT International Application No. PCT/KR2021/007166, filed Jun. 8, 2021, which claims the benefit of priority under 35 U.S.C. § 119 to Korean Patent Application No. 10-2020-0073874, filed Jun. 17, 2020, the contents of which are incorporated herein by reference in their entirety.

### FIELD

The present disclosure relates to a transparent substrate with a multilayer thin film coating. More specifically, the present disclosure relates to a transparent substrate with a multilayer thin film coating capable of improving durability and optical properties.

### BACKGROUND

In the case of a door or window applied to a heating device such as an oven or boiler, while visible rays can be transmitted enough to look into the door or window from the outside, infrared rays can be blocked so that a high temperature inside the heating device is not transmitted to the outside. In addition, durability capable of withstanding a high-temperature heating environment during internal heating is required. In the related art, glass without a coating is used, or in order to obtain durability and low emissivity, hard coating low-E glass formed with a transparent conductive coating layer of a fluorine-doped tin oxide (FTO) coating using a pyrolytic process has been mainly used. However, since such a coating layer has excellent durability to heat, but high emissivity and low infrared reflectance, it is difficult to effectively block the heat transfer from the inside.

As an alternative thereto, it has been considered to apply low-emissivity or low-E glass, in which a low-emissivity layer containing a metal with high reflectance in an infrared region, such as silver (Ag), is deposited as a thin film, to an oven door, or the like. Emissivity refers to the degree to which heat is emitted from the surface of an object during thermal radiation, and has a relation of (emissivity)=1−(reflectance). Therefore, the lower the emissivity, the better the reflection and the more infrared energy is reflected, and accordingly, the heat transfer is reduced and a thermal transmittance coefficient is lowered, thereby increasing a thermal insulation effect. Therefore, when the low-E glass is used for a door or window applied to the heating device, it is possible to effectively block internal heat from being transferred to the outside. However, in the low-E glass to which such a low-emissivity layer is applied, in order to increase the infrared reflectance by lowering the emissivity, it is effective to increase the thickness of a metal functional layer such as silver, and in this case, we have discovered that the initial emissivity, that is, the infrared reflectance is rapidly reduced due to repeated use.

### SUMMARY

### Technical Problem

The present disclosure has been made in an effort to provide a transparent substrate including a multilayer thin film coating with improved durability at a high temperature even with excellent transmittance and emissivity.

However, problems to be solved by exemplary embodiments of the present disclosure are not limited to the above-described problems and may be variously expanded within the scope of the technical idea included in the present disclosure.

### Technical Solution

An exemplary embodiment of the present disclosure provides a transparent substrate with a multilayer thin film coating, in which the multilayer thin film coating includes a lower dielectric layer, a lower protective layer, a metal functional layer having an infrared reflection function, an upper protective layer, and an upper dielectric layer, which are sequentially laminated from the transparent substrate, the lower dielectric layer includes at least one barrier layer and at least one impurity collection layer, and the thickness of the metal function layer is 12 nm or more.

The impurity collection layer may include at least one of tin-zinc oxide (SnZnOₓ), silicon oxide (SiO₂), and silicon oxynitride (SiOₓN_{y}, wherein x>y).

The barrier layer may include silicon nitride.

The barrier layer may include a first barrier layer and a second barrier layer, and the impurity collection layer may include a first impurity collection layer and a second impurity collection layer.

The first barrier layer/first impurity collection layer/second barrier layer/second impurity collection layer may be laminated sequentially in a direction away from the transparent substrate.

The first impurity collection layer may include at least one of silicon oxide (SiO₂) and silicon oxynitride (SiOₓN_{y}, wherein x>y).

The second impurity collection layer may include tin-zinc oxide (SnZnOₓ).

The thickness of the lower protective layer may be 2 nm or more.

The lower protective layer may be thicker than the upper protective layer.

The thickness of the upper protective layer may be 0.3 nm to 0.7 nm.

The lower dielectric layer may include a planarization layer, and the planarization layer may be formed in contact directly under the lower protective layer.

The planarization layer may be formed by doping silicon nitride with zirconium (Zr).

The transparent substrate may further include an overcoat on the upper dielectric layer, in which the overcoat may include titanium oxide (TiO₂).

Each of the lower protective layer and the upper protective layer may include one or more of titanium, nickel, chromium and niobium, or an alloy thereof.

Each of the lower protective layer and the upper protective layer may include a nickel-chromium alloy.

Vertical emissivity (normal emissivity) of the transparent substrate may be 0.035 or less.

An infrared shielding coefficient of the transparent substrate may be 0.55 or less.

A visible light transmittance of the transparent substrate may be 65% to 85%.

The visible light reflectance of the coating surface of the transparent substrate may be 3% to 20%.

Another exemplary embodiment of the present disclosure provides an oven door including the transparent substrate.

### Advantageous Effects

According to an exemplary embodiment of the present disclosure, it is possible to obtain a transparent substrate including a multilayer thin film coating with improved durability at a high temperature even with excellent transmittance and emissivity.

### BRIEF DESCRIPTION OF THE DRAWINGS

FIG. 1 is a diagram illustrating a cross section of a transparent substrate with a multilayer thin film coating according to a first exemplary embodiment of the present disclosure.

FIG. 2 is a diagram illustrating a cross section of a transparent substrate with a multilayer thin film coating according to a second exemplary embodiment of the present disclosure.

FIGS. 3A and 3B are TOF-SIMS graphs for confirming whether sodium is diffused in a transparent substrate with a multilayer thin film coating according to Comparative Example 1 and Example 2, respectively.

FIG. 4 is a diagram illustrating a result of evaluating high-temperature durability of a transparent substrate with a multilayer thin film coating according to Example 1 of the present disclosure and Comparative Example 1.

### DETAILED DESCRIPTION

The present disclosure will be described more fully hereinafter with reference to the accompanying drawings, in which various exemplary embodiments of the disclosure are shown. The present disclosure may be implemented in various different forms and is not limited to embodiments described herein.

A part irrelevant to the description will be omitted to clearly describe the present disclosure, and like or similar components will be designated by like reference numerals throughout the specification.

In addition, since the size and thickness of each component illustrated in the drawings are arbitrarily illustrated for convenience of description, the present disclosure is not necessarily limited to those illustrated in the drawings. In the drawings, in order to clearly express various layers and regions in the drawings, the thicknesses thereof are enlarged. In addition, in the drawings, for convenience of description, thicknesses of a partial layer and a region are exaggeratedly illustrated.

Terms such as first, second and third are used to describe various parts, components, regions, layers and/or sections, but are not limited thereto. These terms are used only to distinguish one part, component, region, layer or section from the other part, component, region, layer or section. Accordingly, a first part, component, region, layer or section to be described below may be referred to as a second part, component, region, layer or section without departing from the scope of the present disclosure.

The terms used herein are only for the purpose of describing specific exemplary embodiments and are not intended to limit the present disclosure. The singular forms used herein include plural forms, unless expressly indicated to the contrary thereto. The “comprising” used herein means embodying a specific feature, region, integer, step, operation, element and/or component, and the existence or addition of other features, regions, integers, steps, operations, elements, and/or components is not excluded.

When a part refers to being “above” or “on” the other part, or “below” or “under” the other part, the part may be disposed directly above or below the other part or another part may be included therebetween. In contrast, when a part refers to being “directly above” or “directly below” the other part, another part is not interposed therebetween.

Unless defined otherwise, all terms including technical and scientific terms used herein have the same meaning as commonly understood by those skilled in the art to which the present disclosure pertains. Commonly used predefined terms are further interpreted as having a meaning consistent with the relevant technical literature and the present disclosure, and are not to be construed as ideal or very formal meanings unless defined otherwise.

In the present disclosure, the terms “emissivity” and “transmittance” are used as those commonly known in the art. The “emissivity” is a measure of how much light is absorbed and reflected at a given wavelength. In general, the following equation is satisfied.

(Emissivity)=1−(Reflectance)

In this specification, the term “transmittance” refers to visible light transmittance.

Unless defined otherwise, all terms including technical and scientific terms used herein have the same meaning as commonly understood by those skilled in the art to which the present disclosure pertains. Commonly used predefined terms are further interpreted as having a meaning consistent with the relevant technical literature and the present disclosure, and are not to be construed as ideal or very formal meanings unless defined otherwise.

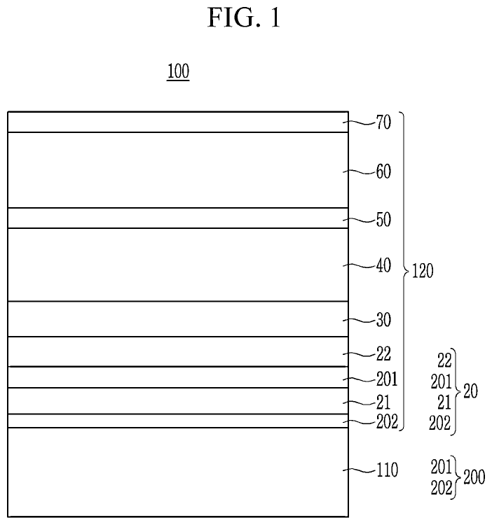

FIG. 1 is a diagram illustrating a cross section of a transparent substrate with a multilayer thin film coating according to a first exemplary embodiment of the present disclosure. A transparent substrate 100 with the multilayer thin film coating of FIG. 1 is merely illustrative of the present disclosure, and the present disclosure is not limited thereto. Accordingly, the transparent substrate 100 with the multilayer thin film coating of FIG. 1 may be modified into various shapes.

Referring to FIG. 1, the transparent substrate 100 with the multilayer thin film coating according to an exemplary embodiment of the present disclosure includes a transparent substrate 110 and a multilayer thin film coating 120 formed on the transparent substrate 110.

The transparent substrate 110 is not particularly limited, but is preferably made of a hard inorganic material such as glass or an organic material of a polymer substrate.

The multilayer thin film coating 120 includes a lower dielectric layer 20, a lower protective layer 30, a metal functional layer 40 having an infrared reflection function, an upper protective layer 50, and an upper dielectric layer 60, which are sequentially formed from the transparent substrate 110. The multilayer thin film coating 120 further includes an overcoat 70 on the upper portion of the upper dielectric layer 60, that is, on one side in a direction away from the transparent substrate 110. In addition, the lower dielectric layer 20 includes at least one barrier layer 21 and 22 and at least one impurity collection layer 200.

The metal functional layer 40 has infrared (IR) reflection characteristics. The metal function layer 40 may include one or more of gold (Au), copper (Cu), palladium (Pd), aluminum (Al), and silver (Ag). Specifically, silver or a silver alloy may be included. The silver alloy may include a silver-gold alloy and a silver-palladium alloy. Among them, silver having low resistivity may be particularly preferably included.

The upper protective layer 50 is included on the upper surface of the metal functional layer 40. The upper protective layer 50 may prevent the metal functional layer 40 from being oxidized and corroded. In an exemplary embodiment of the present disclosure the thickness of the upper protective layer 50 may be 0.3 nm to 0.7 nm. In a preferred exemplary embodiment, the thickness of the upper protective layer 50 may be 0.3 nm to 0.5 nm. The upper protective layer 50 may include one or more of titanium, nickel, chromium, and niobium. More specifically, the upper protective layer 50 may include a nickel-chromium alloy. Meanwhile, the thickness of the metal function layer 40 may be 12 nm or more, more preferably 15 nm or more. When the thickness of the metal functional layer 40 is less than 12 nm, it is difficult to obtain a thermal insulation property required for being used as glass constituting a high-temperature heating device, for example, an oven door or the like. When the thickness of the metal functional layer 40 is 12 nm or more, preferably 15 nm or more, low emissivity of less than 5% may be obtained, thereby securing the user's safety when used as glass such as an oven door or the like.

However, in the case of using the relatively thick metal functional layer 40 as described above, as the number of repetitions increases during repeated exposure to a high temperature, the thermal insulation performance may be deteriorated. As such, it may be considered that the reason why the thermal insulation performance is lowered by repeating the process at a high temperature is that the free electron mobility in the metal functional layer 40 is lowered. As such, factors for inhibiting free electron mobility may include scattering caused by electrons colliding with the surface of the metal functional layer 40 or scattering caused by collision at a grain boundary inside the metal functional layer 40. Therefore, in order to suppress the functional deterioration as described above, that is, the deterioration of the thermal insulation performance (that is, an increase in emissivity) caused by repeated exposure to a high temperature, it is necessary to suppress electron collision on the surface and the grain boundary of the metal functional layer 40.

In particular, like an exemplary embodiment of the present disclosure, when the metal functional layer 40 is thickened for a high thermal insulation property, a distance between the upper and lower portions of the metal functional layer 40 is relatively large, so that the influence of scattering on the grain boundary is greater than that of scattering on the surface. Accordingly, it is possible to suppress the free electron mobility from being inhibited by suppressing the grain boundary from being increased inside the metal functional layer 40.

However, when a process in which the transparent substrate 100 with the multilayer thin film coating is exposed to a high temperature environment and then cooled is repeated, a metal such as silver included in the metal functional layer 40 may be melted at a high temperature (wetting), and when the temperature of the heating device is lowered again, a process of re-crystallizing the temporarily melted metal is repeated. At this time, impurities such as sodium ions from the transparent substrate 110 in a high temperature state penetrate into the metal functional layer 40 in a wetting state to serve as a seed of the grain boundary. Accordingly, it is possible to prevent a decrease in emissivity due to repeated use at a high temperature by blocking the impurities from moving from the transparent substrate 110 to the metal functional layer 40.

The lower protective layer 30 may be included on a lower surface of the metal functional layer 40. The lower protective layer 30 may not only prevent the metal functional layer 40 from being oxidized and corroded, but also prevent the impurities from moving from the transparent substrate 110 to the metal functional layer 40 as described above. In order to effectively achieve the blocking of the impurities, the thickness of the lower protective layer 30 may be 2 nm or more, more preferably 2.25 nm to 4 nm. When the thickness of the lower protective layer 30 exceeds 4 nm, a single plate transmittance is 60% or less and the emissivity is 20% or more, so that it is unsuitable to be used as an oven door or the like.

In addition, the thickness of the lower protective layer 30 is greater than that of the upper protective layer 60. The thickness of the lower protective layer 30 is greater than that of the upper protective layer 50, thereby further increasing durability, particularly chemical durability. In the transparent substrate 100 formed with the multilayer thin film coating 120, shearing stress is applied to the upper dielectric layer 60 located thereon, and as a result, the peeling of the multilayer thin film coating 120 mainly occurs in the lower portion of the laminated structure, that is, on the side close to the transparent substrate 110. In an exemplary embodiment of the present disclosure, the thickness of the lower protective layer 30 is greater than that of the upper protective layer 50 to more effectively prevent corrosion and peeling that may occur on the side close to the transparent substrate 110. Accordingly, it is possible to obtain more excellent durability than that of a case where the sum thickness of the lower protective layer 30 and the upper protective layer 50 is the same. As a result, it is possible to obtain the multilayer thin film coating 120 with improved durability by suppressing both corrosion and peeling caused thereby even while achieving the low-emissivity performance, that is, low emissivity and high transmittance of the multilayer thin film coating 120.

In particular, when used in an environment exposed to a high temperature, such as an oven door, a metal such as silver included in the metal functional layer 40 may be melted at a high temperature (wetting), and when the temperature of the heating device is lowered again, the process of recrystallizing the temporarily melted metal is repeated. However, during recrystallization, impurities and the like may be included to cause the corrosion of the metal or the peeling of the metal functional layer 40.

However, according to an exemplary embodiment of the present disclosure, protective layers in a predetermined thickness range are provided on the upper and lower portions of the metal functional layer 40, respectively, and in particular, at this time, the thickness of the lower protective layer 30 is greater than that of the upper protective layer 50 to suppress the occurrence of such corrosion and peeling.

The lower protective layer 30 may include one or more of titanium, nickel, chromium, and niobium. More specifically, the lower protective layer 30 may include a nickel-chromium alloy.

In addition, the lower dielectric layer 20 is included between the transparent substrate 110 and the metal functional layer 40, more specifically between the lower protective layer 30 and the transparent substrate 110. In addition, the lower dielectric layer 20 may include at least one layer, and as at least one layer included in the lower dielectric layer 20, barrier layers 21 and 22 are included, thereby effectively blocking impurities from moving from the transparent substrate 110 to the metal function layer 40. The lower dielectric layer 20 may include metal oxide, metal nitride, or metal oxynitride. The metal may include one or more of titanium (Ti), hafnium (Hf), zirconium (Zr), zinc (Zn), indium (In), tin (Sn), and silicon (Si), preferably silicon nitride (Si₃N₄).

The lower dielectric layer 20 may include at least one impurity collection layer 200. That is, the lower dielectric layer 20 may include one or more impurity collection layers 200 surrounded by the barrier layers 21 and 22 up and down, except for a bonding portion to the transparent substrate 110.

The impurity collection layer 200 collects impurities such as sodium ions or the like that are diffused from the lower portion, that is, the transparent substrate 110 in the multilayer thin film coating 120 to function to prevent these impurities from being mixed into the metal functional layer 40. To this end, the impurity collection layer 200 may include at least one of tin-zinc oxide (SnZnOₓ), silicon oxide (SiO₂), and silicon oxynitride (SiOₓN_{y}, wherein x>y). As a result, impurities such as sodium and the like that are diffused from the transparent substrate 110 may be combined with the impurity collection layer 200 while being diffused upward to prevent further diffusion.

One or more impurity collection layers 200 may be included, and may include a first impurity collection layer 201 and a second impurity collection layer 202 as illustrated in FIG. 1. That is, in this configuration, the lower dielectric layer 20 may include the first barrier layer 21 and the second barrier layer 22 sequentially laminated from the transparent substrate 110, and the first impurity collection layer 201 may be disposed between the first barrier layer 21 and the second barrier layer 22, and the second impurity collection layer 202 may be disposed between the transparent substrate 110 and the first barrier layer 21. At this time, the sum thickness of the first barrier layer 21 and the second barrier layer 22 may be 30 nm to 45 nm. Of course, in such a structure, only either the first impurity collection layer 201 or the second impurity collection layer 202 may also be provided.

As illustrated in FIG. 1, when the first impurity collection layer 201 and the second impurity collection layer 202 are included, the impurities diffused from the transparent substrate 110 are collected primarily by the second impurity collection layer 202, and impurities that are not collected in the second impurity collection layer 202, but further diffused upward are also collected and removed by the first impurity collection layer 201, thereby more effectively blocking the mixing of the impurities into the metal functional layer 40.

In this case, the first impurity collection layer 201 includes at least one of silicon oxide (SiO₂) and silicon oxynitride (SiOₓN_{y}, wherein x>y), and the second impurity collection layer 202 is preferably tin-zinc oxide (SnZnOₓ), but is not limited thereto.

The thicknesses of the first impurity collection layer 201 and the second impurity collection layer 202 are not particularly limited, but may be 3 nm to 10 nm, respectively. When the thicknesses of the first impurity collection layer 201 and the second impurity collection layer 202 are less than 3 nm, it is difficult to obtain an impurity collection effect, and when the thicknesses thereof are more than 10 nm, it is not preferable that there is a possibility of oxidizing the metal functional layer by oxygen movement during heat treatment.

As such, since the lower dielectric layer 20 includes at least one impurity collection layer 200 disposed between the lower protective layer 30 and the transparent substrate 110, it is possible to more reliably block the impurities diffused from the transparent substrate 110 from reaching the metal functional layer 40.

On the upper surface of the upper protective layer 50, the upper dielectric layer 60 that blocks oxygen, moisture, and the like from penetrating therein is included. That is, the upper protective layer 50 may be laminated between the metal functional layer 40 and the upper dielectric layer 60. The upper dielectric layer 60 includes at least one dielectric layer. The dielectric layer may include metal oxide, metal nitride, or metal oxynitride. The metal may include one or more of titanium (Ti), hafnium (Hf), zirconium (Zr), zinc (Zn), indium (In), tin (Sn), and silicon (Si). Preferably, the metal may include silicon nitride (Si₃N₄). The upper dielectric layer 60 may also be formed as a single layer as illustrated in FIG. 1, or may be a laminate of two or more layers, but is not particularly limited.

In addition, the upper dielectric layer 60 may be in direct contact with the upper protective layer 50 to be formed directly on the upper protective layer 50. The thickness of the upper dielectric layer 60 may be 30 nm or more, more specifically 35 nm to 50 nm. In addition, the upper dielectric layer 60 may be thicker than the lower dielectric layer 20, and for example, a thickness ratio of the upper dielectric layer 60 to the lower dielectric layer 20 may be 1.1:1 to 1.4:1. As such, it is possible to control reflection colors of the multilayer thin film coating and increase the transmittance at the same time by controlling the thickness ratio of the upper dielectric layer 60 and the lower dielectric layer 20 as described above.

In addition, the upper dielectric layer 60 may be further doped with aluminum or the like. By doping aluminum, the dielectric layer may be smoothly formed in the manufacturing process. In addition, in addition to aluminum, various doping agents, such as fluorine, carbon, nitrogen, boron, phosphorus, zirconium, zinc, or the like, may be used to improve the formation rate of the dielectric layer by sputtering as well as the optical properties of the film.

In addition, the outermost side of the multilayer thin film coating 120 may further include an overcoat 70. That is, the overcoat 70 is included on the upper portion of the upper protective layer 50, that is, on one side away from the transparent substrate 110. The overcoat 70 may include at least one selected from titanium oxide (TiO), titanium nitride (TiN), titanium oxynitride (TiON), zirconium oxide (ZrO), zirconium nitride (ZrN), and zirconium oxynitride (ZrON). Preferably, the overcoat 70 may include titanium oxide (TiO₂). By including the overcoat 70, it is possible to prevent damage to the layers included in the multilayer thin film coating 120. The thickness of the overcoat 70 may be 1 nm to 5 nm.

As such, since the lower dielectric layer 20 includes at least one impurity collection layer 200 disposed between the lower protective layer 30 and the transparent substrate 110, it is possible to prevent the impurities diffused from the transparent substrate 110 from reaching the metal functional layer 40. Accordingly, even though the metal functional layer 40 having a large thickness of 12 nm or more is used, a high temperature insulation property may be maintained without lowering the emissivity even in an environment where heating and cooling to a high temperature are repeated when a heating device or the like is applied. In addition, since the durability at a high temperature is improved, it is possible to prevent all or a part of the multilayer thin film coating from being peeled after being exposed to the high temperature.

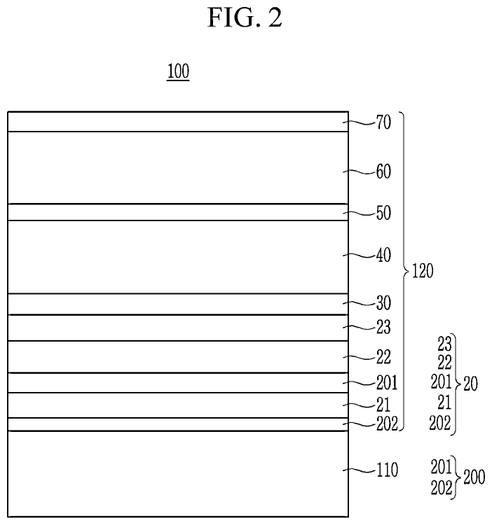

Next, a second exemplary embodiment of the present disclosure will be described with reference to FIG. 2. FIG. 2 is a diagram illustrating a cross section of a transparent substrate 100 with a multilayer thin film coating according to a second exemplary embodiment of the present disclosure.

The second embodiment of the present disclosure has the same configuration as the first embodiment, except that the lower dielectric layer 20 further includes a planarization layer 23 between the second barrier layer 22 and the lower protective layer 30, and thus, the duplicated description will be omitted.

As illustrated in FIG. 2, a multilayer thin film coating 12 of the exemplary embodiment may further include a planarization layer 23 between the second barrier layer 22 and the lower protective layer 30. The planarization layer 23 may be formed by including a doping element in metal oxide, metal nitride, or metal oxynitride. The metal may include one or more of titanium (Ti), hafnium (Hf), zinc (Zn), indium (In), tin (Sn), and silicon (Si). Preferably, the metal may include silicon nitride. The doping element may include zirconium, and may be doped at a concentration of 15 to 30 at %, preferably 15 to 25 at %, based on the total atoms of the planarization layer 23.

In addition, the thickness of the planarization layer 23 may be 5 nm to 15 nm, preferably 10 nm or more and less than 15 nm.

As such, the surface of the metal functional layer 40 is further planarized by providing the planarization layer 23 to improve the resistivity of the metal functional layer 40, thereby preventing the emissivity and the thermal insulation property from being lowered.

Meanwhile, although only one set of multilayer thin film coatings is illustrated in the drawings of the present disclosure, two or more sets of the same multilayer thin film coatings may be laminated to form a multilayer thin film coating, and the present disclosure is not particularly limited.

Due to the above-described configuration, the transparent substrate 100 with the multilayer thin film coating 120 according to exemplary embodiments of the present disclosure has excellent characteristics even in terms of transmittance and reflectance while maintaining excellent emissivity and shielding coefficient.

That is, vertical emissivity (normal emissivity) may be 0.035 or less, and the shielding coefficient may be 0.55 or less. In addition, a visible light transmittance (TL) may be 65% to 85%, and a coated surface reflectance may be 3% to 20%.

The transparent substrate 100 according to an exemplary embodiment of the present disclosure may be used as a door or window included in a heating device such as an oven, a boiler, or the like. In particular, when the transparent substrate 100 is used in such a heating device, even if cycles to be exposed to a high temperature by heating and then cooled are repeated, the emissivity or the thermal insulation property is not decreased, so that high heat inside the device is not transmitted to a user even if used for a long time, and may be safely used. Therefore, it is possible to improve the life of the heating device itself. In addition, even though the transparent substrate 100 is exposed to the high temperature, it is possible to prevent all or part of the multilayer thin film coating from being peeled off, thereby improving the durability.

Hereinafter, the present disclosure will be described in more detail through Experimental Examples. However, these Experimental Examples are only illustrative of the present disclosure, and the present disclosure is not limited thereto.

### EXPERIMENTAL EXAMPLES

Lower dielectric layer/lower protective layer/impurity collection layer/metal functional layer/upper protective layer/upper dielectric layer were sequentially laminated on a transparent substrate as shown in Table 1 to form a transparent substrate with a multilayer thin film coating.

A glass substrate with a thickness of 5 mm (trade name: Hanlite Clear, manufactured by HanGlas Co., Ltd.) was used as the transparent substrate. Si₃N₄ layers were laminated as the first and second barrier layers, SnZnOₓ was laminated as the first impurity collection layer, and SiON was laminated as the second impurity collection layer. Table 1 showed the thicknesses of the first and second barrier layers and the first and second impurity collection layers and whether to form a film. As the lower protective layer, a NiCr layer was formed with different thicknesses as shown in Table 1 below. As the metal functional layer, an Ag layer was formed with a thickness of 15 nm, and as the upper protective layer, a NiCr layer was formed with a thickness of 0.5 nm. As the upper dielectric layer, a Si₃N₄ layer was formed with a thickness of 45 nm.

TABLE 1

| | | | Thick- | | |
|---|---|---|---|---|---|
| | | | ness | Thick- | Thick- |
| | Thickness | Thickness | (nm) of | ness | ness |
| | (nm) of | (nm) of first | second | (nm) | (nm) of |
| | lower | impurity | impurity | of first | second |
| | protective | collection | collection | barrier | barrier |
| | layer | layer | layer | layer | layer |
| Comparative | 2 | — | — | 30 | |
| Example 1 | | | | | |
| Comparative | 1 | — | — | 30 | |
| Example 2 | | | | | |
| Example 1 | 2 | 6 | — | 16 | 16 |
| Example 2 | 2 | 6 | 5 | 16 | 16 |
| Example 3 | 1 | 6 | 5 | 16 | 16 |

<Evaluation 1>

With respect to the transparent substrates with the multilayer thin film coatings of Examples and Comparative Examples having the laminated structure of Table 1, resistance values of the metal functional layers before and after aging were measured to confirm changes in resistance values. That is, a Samsung's NE59J7630SS oven was used as a heating device, and the transparent substrates were heated for 2 hours at a temperature of 443° C. under environments of an external temperature of 21 to 22° C. and an external humidity of RH 50 to 60%, and then cooled (turned on the power and opened the oven door after 1 hour has elapsed to be additionally cooled with air for 2 hours) as 1 cycle, and aged by applying total 20 cycles. The results were shown in Table 2 below.

TABLE 2

| | Initial | | |
|---|---|---|---|
| | resistance | Resistance value | Increased |
| | value | after 20 cycles | amount |
| | [ohm/sq] | [ohm/sq] | (%) |
| Comparative Example 1 | 3.24 | 3.35 | 3.4 |
| Comparative Example 2 | 3.29 | 3.55 | 7.9 |
| Example 1 | 3.12 | 3.21 | 0.9 |
| Example 2 | 3.20 | 3.19 | 0 |
| Example 3 | 3.18 | 3.22 | 1.3 |

As shown in Table 2, it can be seen that, as in Comparative Examples 1 and 2, when the impurity collection layer is not included at all, the resistance values of the metal functional layers rapidly increase due to aging. This is caused by a decrease in free electron mobility, which means that the emissivity is increased and the thermal insulation performance is deteriorated, so that the performance of the oven door is rapidly deteriorated. On the other hand, in the case of Examples 1 to 3 including at least one impurity collection layer, it was confirmed that although the metal functional layer with a thickness of 15 nm was included, the resistance values after aging hardly increased, so that the initial emissivity and thermal insulation performance were maintained as they were. In particular, even in the case of Example 3, in which the thickness of the lower protective layer was relatively thin as 1 nm, it was confirmed that by including two impurity collection layers, Example 3 had significantly superior aging characteristics to Comparative Example 1 with a larger thickness of the lower protective layer.

<Evaluation 2>

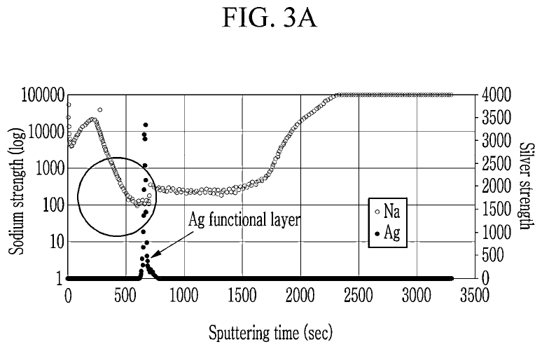

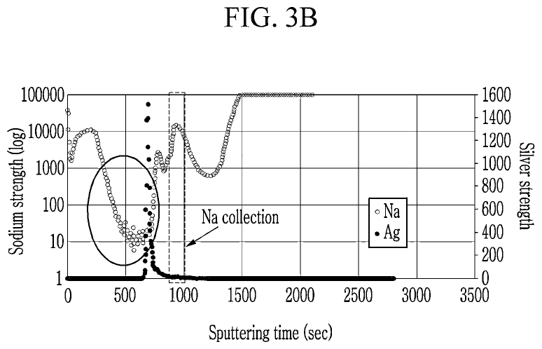

With respect to Comparative Examples 1 and Example 2, results of confirming a sodium diffusion profile by time-of-flight secondary ion mass spectrometry (TOF-SIMS) were illustrated in FIGS. 3A and 3B. FIGS. 3A and 3B are TOF-SIMS graphs for confirming whether sodium is diffused in a transparent substrate with a multilayer thin film coating according to Comparative Example 1 and Example 2, respectively.

As illustrated in FIG. 3A, in the case of Comparative Example 1, it was confirmed that a decrease in sodium strength on the left side was insignificant at a point where a silver concentration rapidly increased, so that sodium was diffused from the transparent substrate corresponding to data on the right side. On the other hand, as illustrated in FIG. 3B, in the case of Example 2, it was confirmed that the sodium strength on the left side was rapidly decreased at the point where the silver concentration rapidly increased, so that the sodium diffusion from the transparent substrate corresponding to the data on the right side was blocked. In particular, it was confirmed that two sodium concentration increasing sections appeared at the right side of the point where the silver concentration rapidly increased, so that sodium was collected in the corresponding sections. As such, by blocking the diffusion of impurities such as sodium from the transparent substrate, the formation of a grain boundary in the metal functional layer is suppressed, thereby preventing an increase in emissivity and a decrease in thermal insulation property due to repeated use at a high temperature.

<Evaluation 3>

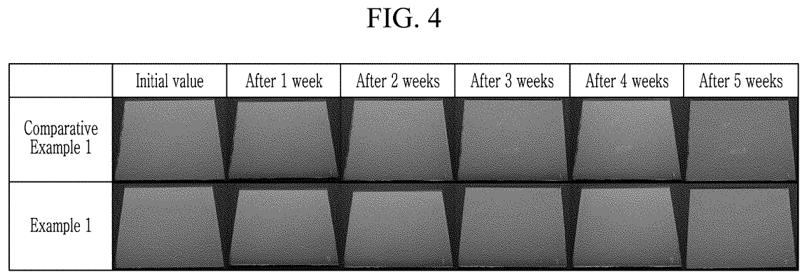

With respect to Example 1 and Comparative Example 1, the results of long-term aging at a high temperature were illustrated in FIG. 4. FIG. 4 is a diagram illustrating a result of evaluating high-temperature durability of a transparent substrate with a multilayer thin film coating according to Example 1 of the present disclosure and Comparative Example 1.

That is, in order to test the durability at the high temperature, the transparent substrate was aged in an oven at a temperature of 350° C. for a long time, and the surface changes of Example 1 and Comparative Example 1 over time were visually observed and photographed, as illustrated in FIG. 4.

As illustrated in FIG. 4, it could be observed that in the case of Example 1 including the impurity collection layer, there was almost no surface change even after 5 weeks had elapsed, but in the case of Comparative Example 1 without impurities, the peeling phenomenon was shown in the vicinity of the center of a sample after about 3 weeks had elapsed.

As such, according to an exemplary embodiment of the present disclosure, in the transparent substrate with the multilayer thin film coating, it was confirmed that even when the emissivity was lowered by increasing the thickness of the metal functional layer to 12 nm or more, the initial performance was maintained excellently without a rapid decrease in performance due to repeated exposure to the high temperature, that is, an increase in emissivity and a decrease in thermal insulation performance. Accordingly, the transparent substrate with the multilayer thin film coating can be suitably used as a door or window (for example, an oven door) of a heating device in which heating to a high temperature and cooling are repeatedly performed. In addition, it was confirmed that the multilayer thin film coating was not peeled off even in the high temperature environment, so that the transparent substrate had excellent durability.

The present disclosure can be manufactured in various different forms, not limited to the above embodiments, and it will be appreciated to those skilled in the present disclosure that the present disclosure may be implemented in other specific forms without changing the technical idea or essential features of the present disclosure. Therefore, it should be appreciated that the aforementioned exemplary embodiments are illustrative in all aspects and are not restricted.

While the above description constitutes the preferred embodiment of the present disclosure, it will be appreciated that the disclosure is susceptible to modification, variation and change without departing from the proper scope and fair meaning of the accompanying claims.

1. A transparent substrate with a multilayer thin film coating, wherein
the multilayer thin film coating includes a lower dielectric layer, a lower protective layer, a metal functional layer having an infrared reflection function, an upper protective layer, and an upper dielectric layer, which are sequentially laminated from the transparent substrate,
the lower dielectric layer includes at least one barrier layer and at least one impurity collection layer, and
the thickness of the metal function layer is 12 nm or more.

2. The transparent substrate of claim 1, wherein:
the impurity collection layer includes at least one of tin-zinc oxide (SnZnOₓ), silicon oxide (SiO₂), and silicon oxynitride (SiOₓN_{y}, wherein x>y).

3. The transparent substrate of claim 1, wherein:
the barrier layer includes silicon nitride.

4. The transparent substrate of claim 1, wherein:
the barrier layer includes a first barrier layer and a second barrier layer, and the impurity collection layer includes a first impurity collection layer and a second impurity collection layer.

5. The transparent substrate of claim 4, wherein:
the first barrier layer/first impurity collection layer/second barrier layer/second impurity collection layer are laminated sequentially in a direction away from the transparent substrate.

6. The transparent substrate of claim 4, wherein:
the first impurity collection layer includes at least one of silicon oxide (SiO₂) and silicon oxynitride (SiOₓN_{y}, wherein x>y).

7. The transparent substrate of claim 4, wherein:
the second impurity collection layer includes tin-zinc oxide (SnZnOₓ).

8. The transparent substrate of claim 1, wherein:
the thickness of the lower protective layer is 2 nm or more.

9. The transparent substrate of claim 1, wherein:
the lower protective layer is thicker than the upper protective layer.

10. The transparent substrate of claim 1, wherein:
the thickness of the upper protective layer is 0.3 nm to 0.7 nm.

11. The transparent substrate of claim 1, wherein:
the lower dielectric layer includes a planarization layer, and the planarization layer is formed in contact directly under the lower protective layer.

12. The transparent substrate of claim 11, wherein:
the planarization layer is formed by doping silicon nitride with zirconium (Zr).

13. The transparent substrate of claim 1, further comprising:
an overcoat on the upper dielectric layer,
wherein the overcoat includes titanium oxide (TiO₂).

14. The transparent substrate of claim 1, wherein:
each of the lower protective layer and the upper protective layer includes one or more of titanium, nickel, chromium and niobium, or an alloy thereof.

15. The transparent substrate of claim 14, wherein:
each of the lower protective layer and the upper protective layer includes a nickel-chromium alloy.

16. The transparent substrate of claim 1, wherein:
vertical emissivity (normal emissivity) is 0.035 or less.

17. The transparent substrate of claim 1, wherein:
a shielding coefficient is 0.55 or less.

18. The transparent substrate of claim 1, wherein:
a visible light transmittance is 65% to 85%.

19. The transparent substrate of claim 1, wherein:
the visible light reflectance of the coating surface is 3% to 20%.

20. An oven door comprising the transparent substrate of claim 1.
